(19) United States
(12) Patent Application Publication
(10) Pub. No.: US 2007/0046862 A1
(43) Pub. Date: Mar. 1, 2007

(54) Microlens array substrate and method of manufacturing microlens array substrate

(75) Inventors: Nobuhiro Umebayashi, Osaka (JP); Youji Yamanaka, Osaka (JP)

Correspondence Address: BIRCH STEWART KOLASCH & BIRCH, PO BOX 747, FALLS CHURCH, VA, 22040-0747, US

(73) Assignee: HITACHI MAXELL, LTD., Ibaraki-shi (JP)

(21) Appl. No.: 11/511,396

(22) Filed: Aug. 29, 2006

(30) Foreign Application Priority Data
Aug. 30, 2005 (JP) 2005-249019
Sep. 16, 2005 (JP) 2005-269444
Jan. 5, 2006 (JP) 2006-000874

(51) Int. Cl. G02F 1/1335

(52) U.S. Cl. 349/95

(57) ABSTRACT

An optical component of the present invention is a microlens array formed on a transparent substrate made of glass and having multiple microlenses made mainly of glass. The adjacent microlenses are coupled by the same glass material as the microlenses. The expansion coefficient of the lenses is substantially equal to the expansion coefficient of the transparent substrate. The thickness δ at the boundary between the adjacent microlenses is 0.1 μm≦δ≦200 μm.

### BACKGROUND OF THE INVENTION

1. Field of the Invention

The present invention relates to a microlens array substrate and a method of manufacturing the same.

2. Description of Related Art

The use of a microlens array in a liquid crystal display has been proposed for achieving high luminance and wide viewing angle. This technique disposes a microlens array on the backside of a transparent substrate to focus back light in such a way that it does not focus on a TFT or black matrix formed on the transparent substrate, thereby enhancing light use efficiency and achieving high luminance.

Japanese Unexamined Patent Publication No. 8-166502 discloses a method of producing a microlens array formed of a glass. This method deposits a film of photosensitive glass paste composed of glass powder and photosensitive resin, on the substrate. And then, it performs exposure, development and heat treatment, thereby producing a microlens array.

Specifically, in the process of making a lens pattern before heat treatment, exposure is performed twice using two kinds of photomasks to form the lens pattern having two steps. The lens pattern is then heat-treated using rheology with melting of glass powder to thereby produce a lens having a desired shape. Such a method produces a lens using melting of glass during the heat treatment, thus it is necessary that a gap exists at least between lenses. This is because, if adjacent lens patterns contact with each other, fused glass acts in the way to minimize the surface area of the lens shape, which increases a curvature radius of the lens to cause the lens to have a flat shape.

It is possible to reduce the temperature of the heat treatment to maintain high viscosity when fusing glass, thereby restricting the flow of the glass between adjacent lens patterns and thus preventing the glass from becoming flat. However, in the case of creating a lens pattern having two steps as described in Japanese Unexamined Patent Publication No. 8-166502, the steps remain by the restriction of glass flow, which makes it difficult to obtain a desired spherical surface. It is possible to become closer to the spherical shape by using a larger number of photomasks having different ratio of apertures and light shielding portions and by increasing the number of steps in the lens pattern before the heat treatment with an increase of the times of exposures. However, this increases the process steps and is thus not efficient in terms of productivity.

The inventors of the present invention have found by experiment that the method of manufacturing a microlens array disclosed in Japanese Unexamined Patent Publication No. 8-166502 has a further drawback. This drawback is described hereinafter in detail with reference to FIGS. 19A to 19D. As shown in FIG. 19A, photosensitive glass paste is deposited on a glass substrate 1 and then exposed and developed to thereby create a lens pattern 2. The lens pattern 2 is independent from each other and a thickness in a boundary between adjacent lenses is 0.

Then, heat treatment is performed on the lens pattern 2. As a result, photosensitive resin is decomposed at about 400° C. and burned at about 600° C. In the microlens 3, which is created thereby, adjacent lenses are completely separated from each other.

FIG. 20 is a photograph of a hexagonal microlens array after burning. FIG. 21 is a three dimensional view of the microlens. The photograph and the three dimensional view show that the adjacent lenses are completely separated from each other. As shown in the enlarged view of FIG. 19C, the lens pattern 2 contracts in the planar direction by burning, and the outer edge of the lens rises upward. As a result, the lens is transformed into an aspherical shape, which deteriorates focal power. If the lens pattern 2 is formed into a cylindrical shape, it contracts in the planar direction by burning, and the outer edge of the lens rises upward to be higher than the center, thereby creating a hollowed shape shown in FIG. 19D. As a result that the outer edge of the lenses rises upward due to burning, the lens is transformed into an aspherical shape in this case as well.

The present invention has been accomplished to solve the above problems and an object of the present invention is thus to provide an optic and a microlens array substrate having high focal power, and a method of manufacturing the same.

In addition, if a microlens array is formed on a transparent substrate by the manufacturing method disclosed in Japanese Unexamined Patent Publication No. 8-166502, various problems occur by a difference in thermal expansion coefficient between the transparent substrate and the microlens array. FIG. 22 is a partial sectional view of a microlens array substrate in which a microlens array is formed on a transparent substrate. A microlens array 200 which includes a plurality of microlenses 202 are formed on a transparent substrate 201. In the example of FIG. 22, the adjacent microlenses 202 are coupled by a coupling portion 211. Preferably, the transparent substrate 201 and the microlens 202 may be made of glass.

The microlens array 200 is formed on the transparent substrate 201 by exposing photosensitive glass paste containing glass powder to light and developing and burning the result. If there is a difference in thermal expansion coefficient between the glass powder and the transparent substrate 201, a stress remains between the microlens array 200 after burning and the transparent substrate 201, which causes residual strain to occur. An experiment uses a material of 70*10⁻⁷(/° C.) as glass powder and a material of 38*10⁻⁷(/° C.) as the transparent substrate 201. The stress that remains due to a difference in thermal expansion coefficient causes birefringence to occur in the microlens array 200 to deteriorate polarization. The birefringence adversely affects the light passing through the microlens array 200. Especially, because the microlens array substrate is used in a liquid crystal display and polarized light is incident thereon, the polarization direction of light rotates due to birefringence, which degrades display quality. Further, if birefringence occurs uniformly over the microlens array 200, it would be easy to take measures against it; however, because birefringence is unevenly distributed, it is difficult to take any measures.

Further, the stress due to a difference in thermal expansion coefficient can cause crack to occur in the microlens array 200 at the boundary of the microlenses 202. In addition, peeling can occur on the surface of the glass transparent substrate 201. Particularly, the peeling on the surface is likely to occur if a transparent substrate is made of hard glass.

The present invention has been accomplished to solve the above problems and another object of the present invention is thus to provide an optical component and a microlens array substrate capable of suppressing the occurrence of birefringence or crack which occur due to a difference in thermal expansion coefficient between a transparent substrate and an optical functional portion such as a microlens array and thus providing high optical performance, and a method of manufacturing the same.

The residual stress and residual strain that occur due to a difference in thermal expansion coefficient causes a problem that the microlens array substrate can be warped in such a way that the transparent substrate 201 is convex and the microlens array 200 is concave.

Such a problem is particularly significant when a plurality of microlens array substrates are produced using a mother substrate. When a plurality of microlens array substrate are produced using a mother substrate, a number of microlenses are formed with no space therebetween all over the mother substrate, thereby producing a large-scale microlens array. Therefore, the warpage of the mother substrate caused by residual stress and residual strain that occur due to a difference in thermal expansion coefficient between the substrate and the microlens array increases; accordingly, the warpage of a plurality of microlens array substrates which are produced from the mother substrate increases.

The warpage of the microlens array substrate adversely affects the light passing through the microlens. Particularly, the use of such a microlens array substrate having warpage for a liquid crystal display causes deterioration in display quality of the liquid crystal display.

Further, residual stress and residual strain due to a difference in thermal expansion coefficient can cause crack to occur in the microlens array 200 at the boundary of the microlenses 202. In addition, peeling can occur on the surface of the glass transparent substrate 201. Particularly, the peeling on the surface is likely to occur if a transparent substrate is made of hard glass.

The present invention has been accomplished to solve the above problems and an object of the present invention is thus to provide an optical component and a microlens array substrate capable of suppressing the occurrence of warpage of a glass substrate or crack of a microlens array due to a difference in thermal expansion coefficient between a glass substrate and a microlens array, and a method of manufacturing the same.

### SUMMARY OF THE INVENTION

According to an embodiment of the present invention, there is provided an optical component including a transparent substrate, and a plurality of lenses formed on the transparent substrate and made mainly of glass, wherein adjacent lenses are coupled by the same glass material as the lenses, and an expansion coefficient of the lenses is substantially equal to an expansion coefficient of the transparent substrate.

The thickness δ of a coupling portion between the adjacent lenses is preferably 0.1 μm≦δ≦200 μm. Further, when a curve of a cross-section of a given line connecting between both foot ends of each lens through a center top of the lens is g(x), and a curve of an ideal sphere fitted to g(x) by least squares method is f(x), a spherical deviation indicated by a root mean square value (RMS value) of a difference in height between f(x) and g(x) is preferably 0.05 μm or smaller if the lens is a spherical lens. Further, a surface roughness Ra of the lenses is preferably 0.05 μm or smaller. The transparent substrate in a preferred embodiment is a transparent substrate where an electrode is formed, which a liquid crystal display consists of.

Preferably, the lenses contain a first glass material and a second glass material, and if an expansion coefficient of the first glass material is α1, an expansion coefficient of the second glass material is α2, and an expansion coefficient of the transparent substrate is αb, α1<αb<α2 is satisfied.

The refractive index of the first glass material and the refractive index of the second glass material are preferably substantially equal. Further, the average particulate diameter of the first glass material is preferably 50 nm or smaller.

According to another embodiment of the present invention, there is provided a microlens array substrate including a glass substrate and a plurality of microlenses formed on the glass substrate and made mainly of glass, wherein adjacent microlenses are coupled by the same glass material as the lenses, and an expansion coefficient of the microlenses is substantially equal to an expansion coefficient of the glass substrate.

The thickness δ of a coupling portion between the adjacent microlenses is preferably 0.1≦δ≦200 μm. Further, when a curve of a cross-section of a given line connecting between both foot ends of each lens through a center top of the lens is g(x), and a curve of an ideal sphere fitted to g(x) by least squares method is f(x), a spherical deviation indicated by a root mean square value (RMS value) of a difference in height between f(x) and g(x) is preferably 0.05 μm or smaller if the microlens is a spherical lens. Further, a surface roughness Ra of the microlenses is preferably 0.05 μm or smaller. The glass substrate in a preferred embodiment is a transparent substrate where an electrode is formed, which a liquid crystal display consists of.

Preferably, the microlenses contain a first glass material and a second glass material, and if an expansion coefficient of the first glass material is α1, an expansion coefficient of the second glass material is α2, and an expansion coefficient of the transparent substrate is αb, α1<αb<α2 is satisfied. It is preferred that the refractive index of the first glass material and the refractive index of the second glass material are substantially equal. The effect is significant if adjacent microlenses are coupled by a glass material. The glass substrate in a preferred embodiment is a transparent substrate where an electrode is formed, which a liquid crystal display consists of.

The microlens array substrate in a preferred embodiment satisfies 30*10⁻⁷(/° C.)<αb<50*10⁻⁷(/° C.), 5*10⁻⁷(/° C.)<α1<30*10⁻⁷(/° C.) and 50*10⁻⁷(/° C.)<α2<150*10⁻⁷(/° C.). If a softening point of the first glass material is T1 and a softening point of the second glass material is T2, T1−T2>25° C. is preferably satisfied. Further, if a softening point of the first glass material is T1, the first glass material is preferably ceramic glass or quartz glass of T1>700° C. In addition, if a softening point of the second glass material is T2, 400° C.<T2<675° C. is preferably satisfied. The weight percentage of the first glass material is preferably between 5% and 30% with respect to the second glass material. Further preferably, the average particle diameter of the first glass material is 50 nm or smaller.

According to an embodiment of the present invention, there is provided a liquid crystal display including a transparent substrate where an electrode is formed; and a plurality of lenses formed on the transparent substrate and made mainly of glass, wherein adjacent lenses are coupled by the same glass material as the lenses, and an expansion coefficient of the lenses is substantially equal to an expansion coefficient of the transparent substrate.

According to another embodiment of the present invention, there is provided a liquid crystal display including a glass substrate where an electrode is formed; and a plurality of microlenses formed on the glass substrate and made mainly of glass, wherein adjacent microlenses are coupled by the same glass material as the lenses, and an expansion coefficient of the microlenses is substantially equal to an expansion coefficient of the glass substrate.

According to another embodiment of the present invention, there is provided a method of manufacturing an optical component including a transparent substrate and a plurality of lenses formed on the transparent substrate and made mainly of glass, including depositing on the transparent substrate a lens formation layer where a plurality of lenses are formed, and burning the lens formation layer to form the lenses in which adjacent lenses are coupled to each other.

It is preferred that the deposition of the lens formation layer includes coating photosensitive glass paste composed of glass powder and photosensitive resin on the transparent substrate, and exposing the coated photosensitive glass paste to light through a grayscale mask and developing the photosensitive glass paste to form the lenses having a coupling portion. Further, the thickness δ of a coupling portion between the adjacent lenses is preferably 0.1 μm≦δ≦200 μm.

Further, the deposition of the lens formation layer preferably includes depositing on the transparent substrate a lens formation layer containing first glass powder having a lower thermal expansion coefficient than the transparent substrate, and second glass powder having a higher thermal expansion coefficient than the transparent substrate.

It is also preferred that the deposition of the lens formation layer includes coating photosensitive glass paste composed of the first glass powder, the second glass powder and photosensitive resin on the transparent substrate and exposing the coated photosensitive glass paste to light through a grayscale mask and developing the photosensitive glass paste to form a plurality of lenses.

According to another embodiment of the present invention, there is provided a method of manufacturing a microlens array substrate including a glass substrate, and a plurality of microlenses formed on the glass substrate and made mainly of glass, including depositing on the glass substrate a lens formation layer where a plurality of microlenses are formed, and burning the lens formation layer to form the microlenses in which adjacent lenses are coupled to each other.

Preferably, the deposition of the lens formation layer includes coating photosensitive glass paste composed of glass powder and photosensitive resin on the glass substrate, and exposing the coated photosensitive glass paste to light through a grayscale mask and developing the photosensitive glass paste to form the microlenses having a coupling portion. The thickness δ of a coupling portion between the adjacent microlenses after burning is preferably 0.1 μm≦δ≦200 μm.

The method may further include depositing on the glass substrate a lens formation layer containing first glass powder having a lower thermal expansion coefficient than the glass substrate, and second glass powder having a higher thermal expansion coefficient than the glass substrate, on which a plurality of microlenses are formed, and burning the lens formation layer to form the microlenses.

Preferably, the deposition of the lens formation layer includes coating photosensitive glass paste composed of first glass powder, second glass powder, and photosensitive resin on the glass substrate, and exposing the coated photosensitive glass paste to light through a grayscale mask and developing the photosensitive glass paste to form the microlenses.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1A, is a view showing a method of manufacturing a microlens array substrate according to an embodiment of the preset invention;

FIG. 1B is a view showing a method of manufacturing a microlens array substrate according to an embodiment of the preset invention;

FIG. 1C is a view showing a method of manufacturing a microlens array substrate according to an embodiment of the preset invention;

FIG. 1D is a view showing a method of manufacturing a microlens array substrate according to an embodiment of the preset invention;

FIG. 1E is a view showing a method of manufacturing a microlens array substrate according to an embodiment of the preset invention;

FIG. 2A is a view showing a relationship between the distribution of transmittance of a gray mask and the structure of a lens formation layers after exposure and development;

FIG. 2B is a view showing a relationship between the distribution of transmittance of a gray mask and the structure of a lens formation layers after exposure and development;

FIG. 3 is a graph showing a change in temperature during a heat treatment process;

FIG. 4 is a sectional view showing a change in structure due to heat treatment;

FIG. 5 is a photograph of a microlens array formed by a manufacturing method according to an embodiment of the preset invention;

FIG. 6 is a three-dimensional view of a microlens array formed by a manufacturing method according to an embodiment of the preset invention;

FIG. 7 is a table showing a relationship of burning temperature, surface roughness Ra, and transmittance;

FIG. 8 is a graph showing a relationship between surface roughness Ra and burning temperature;

FIG. 9 is a graph showing a relationship between transmittance and surface roughness Ra;

FIG. 10 is a graph showing an example of measurements of sphericity of a microlens;

FIG. 11A is a table showing a relationship between spherical deviation and wavefront aberration of a microlens;

FIG. 11B is a graph showing a relationship between spherical deviation and wavefront aberration of a microlens;

FIG. 12A is a view showing a method of manufacturing a microlens array substrate according to an embodiment of the preset invention;

FIG. 12B is a view showing a method of manufacturing a microlens array substrate according to an embodiment of the preset invention;

FIG. 12C is a view showing a method of manufacturing a microlens array substrate according to an embodiment of the preset invention;

FIG. 12D is a view showing a method of manufacturing a microlens array substrate according to an embodiment of the preset invention;

FIG. 12E is a view showing a method of manufacturing a microlens array substrate according to an embodiment of the preset invention;

FIG. 13 is a sectional view showing a liquid crystal display according to an embodiment of the preset invention;

FIG. 14A is a partial sectional view of a microlens array substrate according to an embodiment of the preset invention;

FIG. 14B is a partial sectional view of a microlens array substrate according to an embodiment of the preset invention;

FIG. 15 is a graph showing a comparison of thermal expansion coefficient between components of a microlens array substrate according to an embodiment of the preset invention;

FIG. 16A is a partial sectional view of a microlens array substrate according to an embodiment of the preset invention;

FIG. 16B is a partial sectional view of a microlens array substrate according to an embodiment of the preset invention;

FIG. 17 is a plan view of a mother substrate when viewed from the plane on which microlens arrays are formed;

FIG. 18 is a sectional view of a mother substrate along line XVIII-XVIII in FIG. 17;

FIG. 19A is a view to describe a drawback in a related art;

FIG. 19B is a view to describe a drawback in a related art;

FIG. 19C is a view to describe a drawback in a related art;

FIG. 19D is a view to describe a drawback in a related art;

FIG. 20 is a photograph of a microlens array produced by a manufacturing method according to a related art;

FIG. 21 is a three-dimensional view of a microlens array produced by a manufacturing method according to a related art; and

FIG. 22 is a view to describe a drawback in a related art.

### DESCRIPTION OF THE PREFERRED EMBODIMENTS

Exemplary embodiments of the present invention are described hereinafter with reference to the drawings. The description provided hereinbelow merely illustrates exemplary embodiments of the present invention, and the present invention is not limited to the below-described embodiments. The description hereinbelow is appropriately shortened and simplified to clarify the explanation. A person skilled in the art will be able to easily change, add, or modify various elements of the below-described embodiments, without departing from the scope of the present invention. A “microlens” as described in this specification is not limited to normal convex or concave lenses but includes a cylindrical lens, Fresnel lens, prism, and a “microlens array” refers to a collection of these.

### First Embodiment

A method of manufacturing a microlens array substrate according to a first exemplary embodiment of the present invention is described hereinafter. A manufacturing method of a microlens array substrate of this embodiment includes a process of creating a mask pattern on a dry plate by a laser to form a master grayscale mask, a process of exposing an emulsion plate to light through the master grayscale mask to form a mother grayscale mask, and a process of exposing photosensitive glass paste coated on a transparent substrate to light through the mother grayscale mask to thereby produce a microlens array.

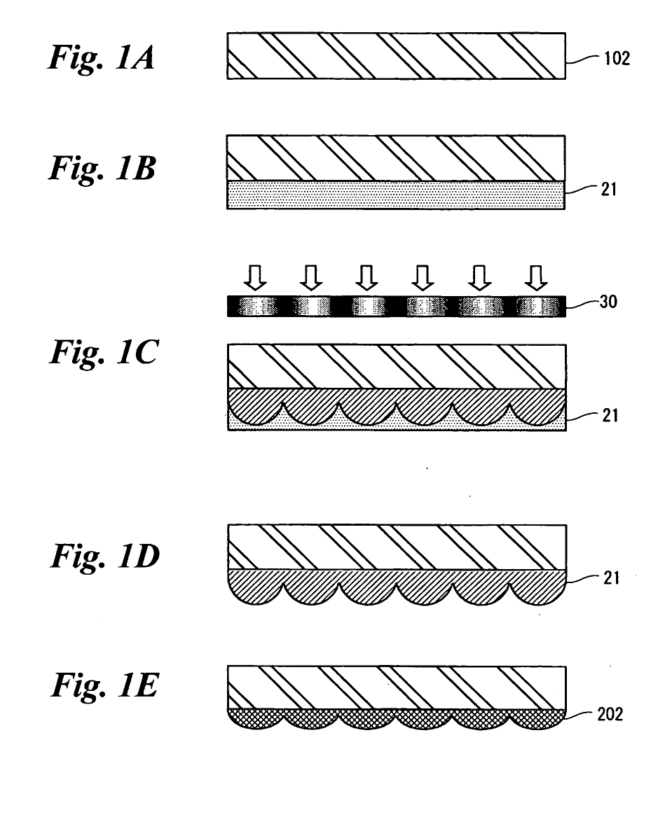

Although it is possible to produce a microlens array using the master grayscale mask only, the use of the mother grayscale mask enables production of a number of large-size microlens arrays. The process of exposing photosensitive glass paste coated on a transparent substrate to light through the mother grayscale mask, which is one of characteristics of this embodiment, is described in detail hereinafter with reference to FIGS. 1A to 1E.

Referring first to FIG. 1A, a transparent substrate 102 which is made of glass is prepared. Referring then to FIG. 1B, photosensitive glass paste is coated and deposited all over one surface of the transparent substrate 102, thereby forming a lens formation layer (optical function formation layer) 21. A deposition method may be spin coating, slit coating, and so on.

The photosensitive glass paste is mainly composed of glass powder and photosensitive resin (resist). To form the photosensitive glass paste, glass block is broken into minute particles of 10 μm or less. Then, silane finishing is performed to admix the glass powder and the photosensitive resin so that the glass powder is dispersed in the photosensitive resin. Photosensitive glass paste is thereby created.

The photosensitive resin is preferably UV curable resin. Preferably, the photosensitive resin is such a material that can be developed by an organic solvent, alkaline solution, or water. It is further preferred that the UV curable resin contains acrylic copolymer having carboxyl group and ethylene unsaturated group at least in side chains, and photoreactive compound. The acrylic copolymer having carboxyl group and ethylene unsaturated group in side chains is a polymer binder, which can be produced by adding ethylene unsaturated group as side chain to acrylic copolymer which is created by copolymerization of unsaturated carboxylic acid and ethylene unsaturated compound.

The unsaturated carboxylic acid may be acrylic acid, methacrylic acid, itaconic acid, crotonic acid, acid anhydride of these, and so on. The ethylene unsaturated compound may be methyl acrylate, methyl methacrylate, ethyl acrylate, and so on. The ethylene unsaturated group in side chains may be vinyl group, allyl group, acrylic group and so on.

The ethylene unsaturated compound having glycidyl group may be glycidyl acrylate, glycidyl methacrylate, allyl glycidyl ether, and so on. The photosensitive resin contained in the photosensitive glass paste may be used in combination with photosensitive polymer or nonphotosensitive polymer other than the above acrylic copolymers as polymer binder.

The photosensitive polymer involves light insoluble and light soluble. The light insoluble one may be a mixture of functional monomer or oligomer having at least one of unsaturated group or the like in one molecule with appropriate polymer binder, a mixture of photosensitive compound such as aromatic diazo compound, aromatic azide compound and an organic compound with appropriate polymer binder, photosensitive polymer obtained by making photosensitive group pendant to existing polymer or reformed photopolymer, diazo resin such as condensate of diazo amine and formaldehyde, and so on. On the other hand, the light soluble one may be a complex of diazo compound and inorganic salt or organic acid, a mixture of quinonediazido group with appropriate polymer binder, a mixture of quinonediazo group with appropriate polymer binder such as phenol-novolak resin, eg. naphthoquinone-1,2-diazido-5-sulfonic ester.

The non-photosensitive polymer involves polyvinyl alcohol, polyvinyl butyral, methacrylate polymer, acrylic ester polymer, acrylic ester-methacrylate ester copolymer, α-methyl styrene polymer, and so on.

The photoreactive compound involves monomer or oligomer containing carbon-to-carbon unsaturated bond having known photoreactivity. For example, photoreactive compound may be allyl acrylate, benzyl acrylate, butoxyethyl acrylate, butoxytriethylene glycol acrylate, and so on. A typical example of oligomer includes polyester acrylate, urethane acrylate, epoxy acrylate and so on.

Photo polymerization initiator used for UV curable resin may be a combination of reducing agent such as benzophenone, methyl O-benzoyl benzoate, 4,4′-bis(dimethylamine)benzophenone, 4,4′-bis(dimethylamine)benzophenone, 4,4′-Dichlorobenzophenone and so on.

In this embodiment, the photosensitive resin is burned down at about 500° C., which is lower than the softening temperature 600° C. of the glass powder. In the example of FIGS. 1A to 1E, negative photoresist in which a light exposed part is cured is employed as photosensitive resin. Compared with positive photoresist, the negative photoresist is preferred to form a polygonal lens. The use of positive photoresist causes a problem that reflowing at high temperature results in rounding of corners of a polygonal shape, thus unable to maintain the polygonal shape. However, if a lens is circular or it is polygonal which does not require high accuracy, the use of positive resist is possible.

Non-alkali glass available from SCHOTT is used as glass powder. This material is: α=37*10⁻⁷(/° C.), n=1.53, central particle diameter D50=0.4 μm. A volume percent (vol %) of the glass contained in photosensitive glass paste is preferably 30% to 50%. It is 40% in this example. The refractive index of the glass powder and the photosensitive resin is preferably substantially equal.

Referring then to FIG. 1C, a grayscale mask 30 is placed on the opposite side of the surface where the lens formation layer 21 is formed and light is exposed therethrough. The intensity of the exposure light applied through the grayscale mask 30 is modified by a lens formation area of the grayscale mask 30. Specifically, the light intensity is modified so that the exposure intensity decreases concentrically from the center of the lens formation area at highest. By the exposure light whose intensity is modified by the lens formation area of the grayscale mask 30, the lens formation layer 21 is cured into a lens shape. Referring further to FIG. 1D, after the exposure is completed, the lens formation layer 21 is developed to thereby remove a non-cured part.

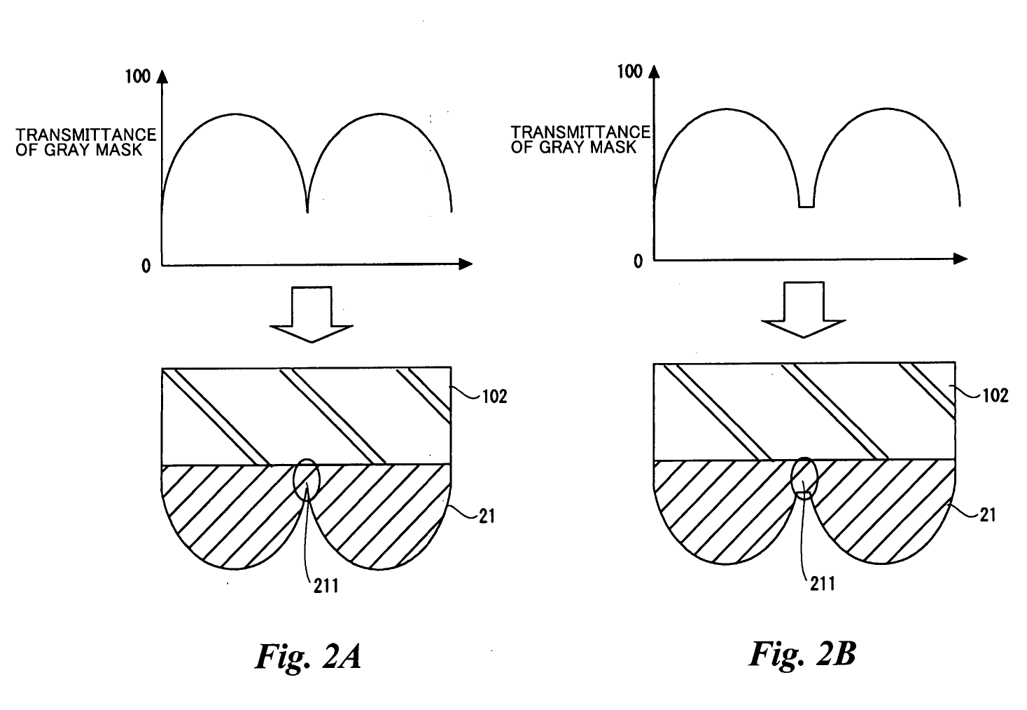

FIGS. 2A and 2B show a correspondence between the transmittance distribution of the grayscale mask 30 and the exposed and developed section of the lens formation layer 21 processed using the gray scale mask 30. As shown in FIGS. 2A and 2B, transmittance distribution of the grayscale mask 30 corresponds to the lens curvature of the lens formation layer 21. As shown in the lower parts of FIGS. 2A and 2B, the adjacent lenses are coupled through a coupling portion 211. The coupling portion 211 shown in FIG. 2A is an acutely-angled V-shape, and the lens formation layer 21 of a certain thickness exists between the bottom of the V-shape and the transparent substrate 102. On the other hand, on the surface of the coupling portion 211 shown in FIG. 2B, a substantially flat portion having a certain width is formed. In order to form such a shape, the grayscale mask 30 has a prescribed transmittance (≠0) in the portion corresponding to the coupling portion 211 so that prescribed exposure light is applied to the photosensitive glass paste.

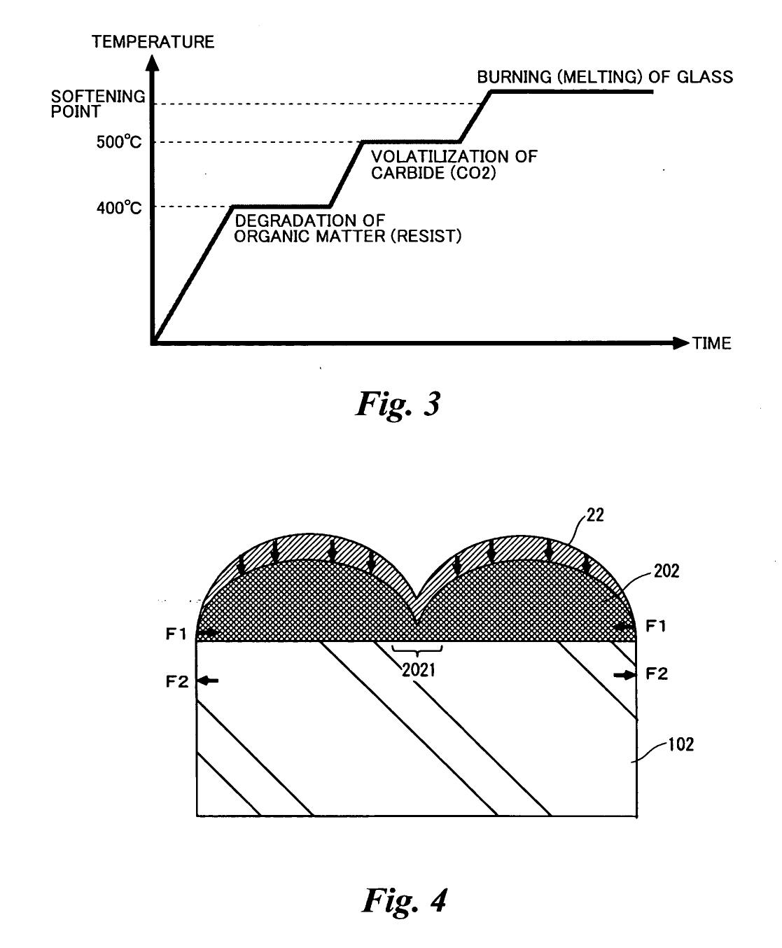

Further, heat treatment (burning) is performed at a temperature higher than a softening temperature of glass, thereby producing the microlens 202 as shown in FIG. 1E. FIG. 3 shows a change in temperature during the heat treatment process. As shown therein, the temperature increases as the heat treatment progresses, and the photosensitive resin is broken down at about 500° C., and carbide is volatilized at about 500° C. Further, the glass is fused at a temperature higher than a glass softening point.

In the microlens array 200 of this embodiment, adjacent lenses are coupled through a glass material which forms the lens. A thickness δ (thickness after burning) of the transparent substrate 102 from the top surface at the boundary between the lenses coupled by the glass material is preferably 0.1 μm≦δ≦200 μm, more preferably 0.5 μm≦δ≦50 μm and further preferably 1 μm≦δ≦10 μm. In this embodiment, the value of δ is 1.0 μm. If δ is larger than 200 μm, a crack occurs during burning due to a stress of a glass film at the boundary. The expansion coefficient of the microlens array 200 and the transparent substrate 102 are preferably substantially equal. Specifically, if the expansion coefficient of the transparent substrate 102 is αb and the expansion coefficient of the microlens array 200 is αm, an absolute value of (αb−αm)/a1 is preferably 0.5 or less. Thus, the ratio of a difference between αb and αm with respect to αb is preferably 50% or less. Equalizing their expansion coefficient prevents stress from occurring between the transparent substrate 102 and the microlens array 200 by heat treatment to cause crack and breakdown of the microlens array 200.

In a method of manufacturing a microlens array substrate according to this embodiment, the focusing characteristics of the lens do not change though the glass is softened and contracted due to heat treatment. The reason is described hereinafter with reference to FIG. 4. FIG. 4 is a partial expanded view that illustrates both of the state before burning in which exposure and development are completed in the lens formation layer 21, and the state in which the microlenses 202 are formed after burning. As shown therein, the microlens array contracts in height (optical axis) direction due to burning. Though a contract force F1 in plane (lens array) direction of the microlens array is acting, the adjacent lenses are coupled through the coupling portion 211 and thus not separated form each other, and the force F1 is relaxed by a reactive force F2 which occurs in the transparent substrate 102. Accordingly, the outer edge of the lens does not rise upward (in the direction away from the transparent substrate 102) and the lens contracts substantially uniformly in the height direction, thereby preventing deterioration of the focusing characteristics of the lens.

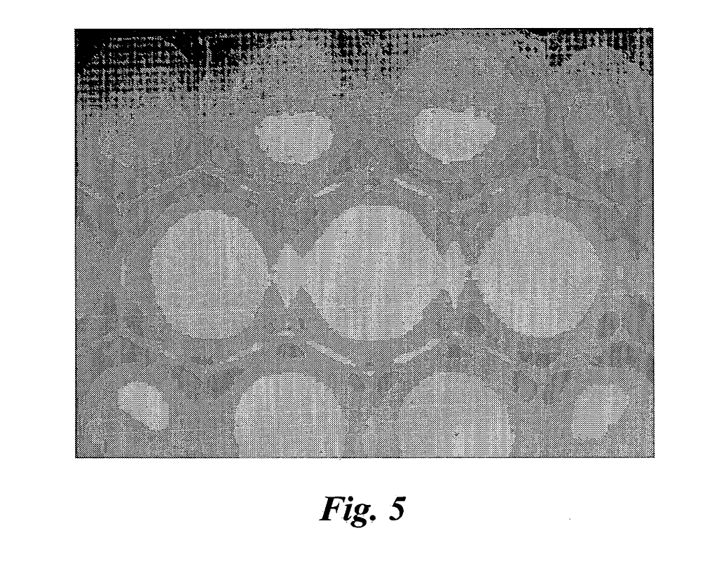

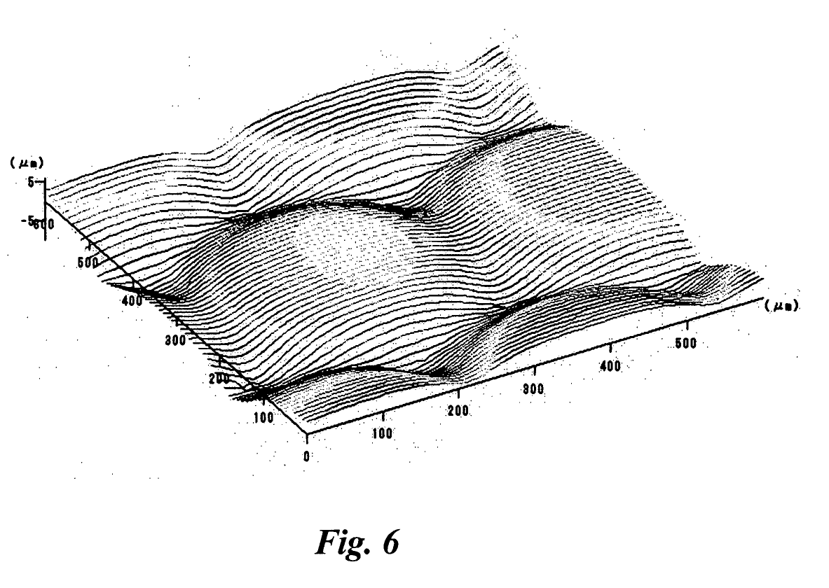

FIG. 5 is a photograph of the microlens after burning which is manufactured by the manufacturing method of this embodiment. FIG. 6 is a three-dimensional view of the microlens. The photograph and the three-dimensional view shows that the lenses are not separated and the lens shape is kept the same.

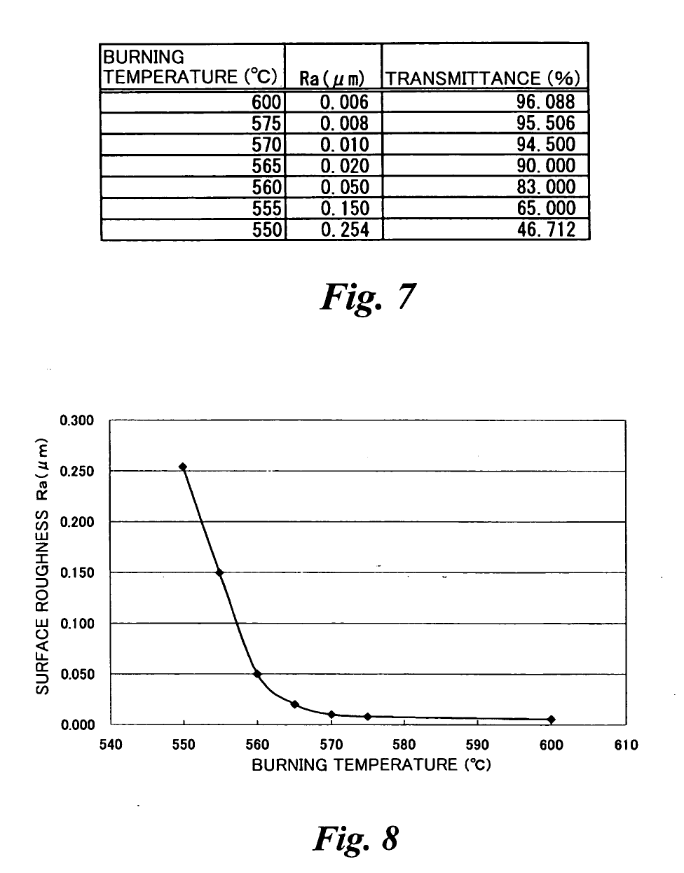

A relationship between burning temperature, surface roughness Ra, and transmittance of the lens formation layer 21. FIG. 7 is a table showing their relationship. In an experiment, a microlens array was produced at different burning temperature from 550° C. to 600° C., and the surface roughness Ra and transmittance of the produced microlens array were measured. The roughness was measured using a laser microscopy (noncontact 3D measuring machine, NH3 available from Mitaka Kohki. Co., Ltd.) with cutoff of 80 μm and measurement length of 480 μm. The transmittance was measured using a spectroscope available from Shimadzu Corporation, and average transmittance when a wavelength is 400 to 800 nm was measured.

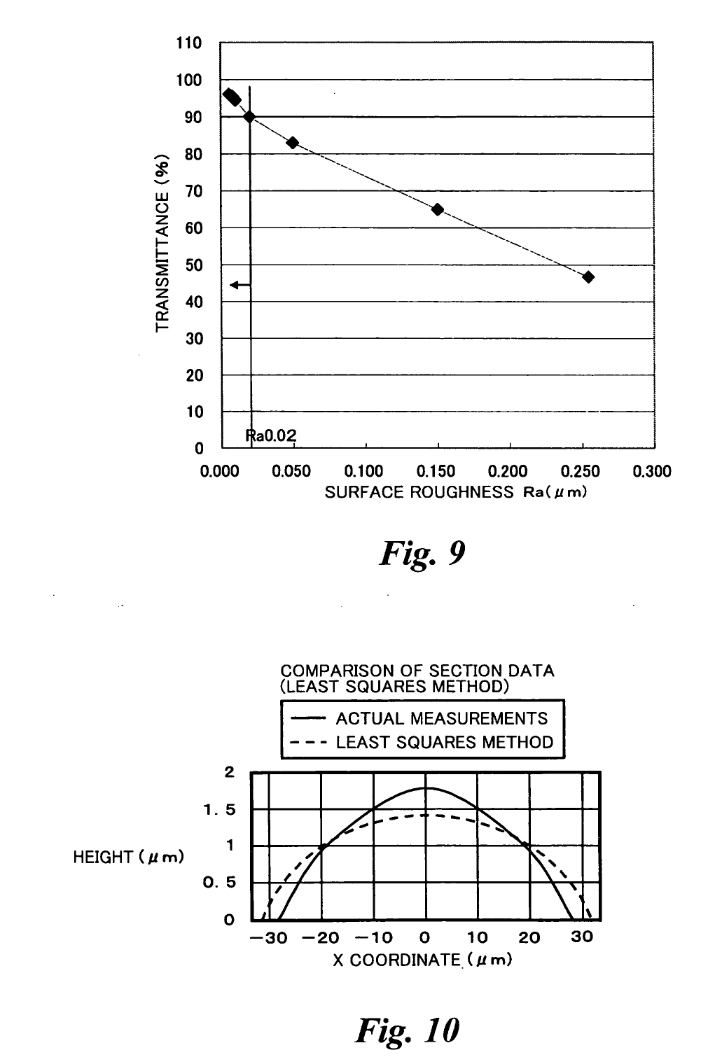

FIGS. 8 and 9 are a graph which plots the relationship of burning temperature and surface roughness and a graph which plots the relationship of surface roughness and transmittance, respectively, based on the data shown in the table of FIG. 7. In the microlens array used in a liquid crystal display, the transmittance is preferably 83% or higher, and more preferably 90% or higher. As shown in FIG. 9, the transmittance of 83% or higher can be obtained when the surface roughness Ra is 0.05 μm or less, and the transmittance of 90% or higher can be obtained when the surface roughness Ra is 0.02 μm or less. Further, as shown in FIG. 8, the surface roughness Ra of 0.05 μm or less can be obtained when the burning temperature is about 560° C. or higher, and the surface roughness Ra of 0.02 μm or less can be obtained when the burning temperature is about 565° C. or higher.

Another indicator for evaluating the stability of a lens curvature of the microlens 202 is sphericity of a lens. The RMS (root mean square) value for evaluating the sphericity of a lens can be expressed as follows:

$$rms = \sqrt{{\sum }_{i = 0}^{n} {( f ( i ) - g ( i ) )}^{2} / n} \qquad ( 1 )$$

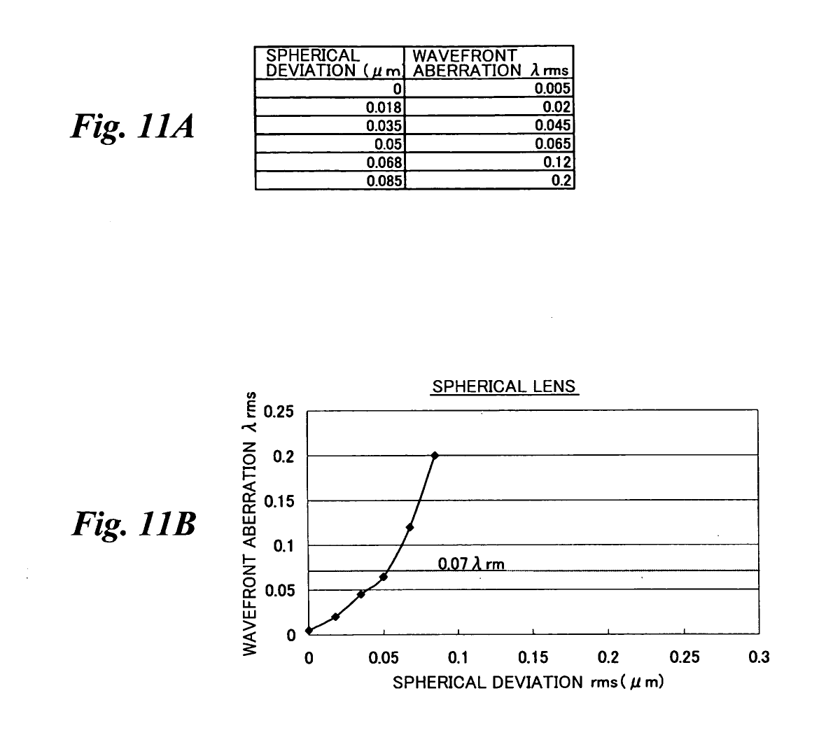

FIG. 10 is a graph showing the measurements of the sphericity of a microlens. If a curve of a cross-section of a given line which connects between the both ends of a lens through the center of a microlens is g(x), and a curve of an ideal sphere fitted to g(x) by least squares method is f(g), the sphericity of the lens is evaluated by examining a root mean square value (RMS value) of a difference in height between f(g) and g(x) as spherical deviation. As this value is smaller, the lens curvature is more stable, being closer to an ideal sphere. FIG. 11A is a table showing a relationship between spherical deviation and wavefront aberration of a microlens when it is a spherical lens, and FIG. 11B is a graph showing the same. According to Maréchal criterion, a typical lens function can be exerted if a wavefront aberration is 0.07 λrms. Thus, as shown in FIGS. 11A and 11B, the spherical deviation of a spherical lens needs to be 0.05 μm or less. Specifically, the spherical deviation of a spherical lens needs to be between 0 and 0.05 μm.

### Second Embodiment

The first embodiment described above employs negative photoresist for photosensitive resin in photosensitive glass paste. On the other hand, a second exemplary embodiment of the present invention employs positive photoresist in which a light-exposed part is decomposed and solubility to a solvent increases therein.

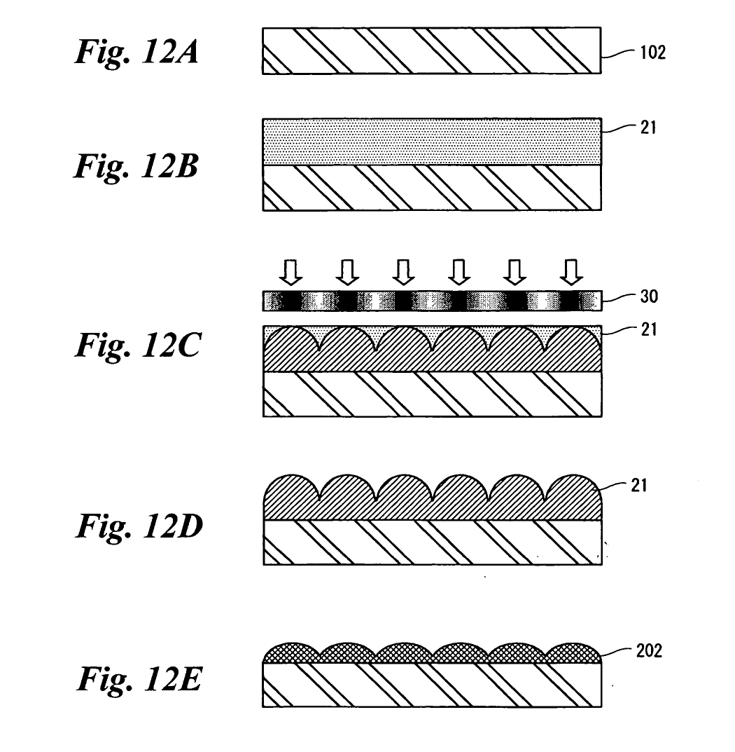

A method of manufacturing a microlens array substrate according to the second embodiment is described hereinafter with reference to FIGS. 12A to 12E. Referring first to FIG. 1A, a transparent substrate 102 which is made of glass is prepared. Referring then to FIG. 1B, photosensitive glass paste is coated and deposited all over one surface of the transparent substrate 102, thereby forming a lens formation layer 21.

Referring further, to FIG. 12C, a grayscale mask 30 is placed above the lens formation layer 21 and light is applied therethrough. The intensity of the exposure light applied through the grayscale mask 30 is modified by a lens formation area of the grayscale mask 30. Specifically, the light intensity is modified so that the exposure intensity increases concentrically from the center of the lens formation area at lowest. As a result of applying the exposure light whose intensity is modified by the lens formation area of the grayscale mask 30, the part of the lens formation layer 21 except for the lens shape area is decomposed by a developer.

Referring further to FIG. 12D, after the exposure is completed, the lens formation layer 21 is developed to thereby remove a decomposed part. In the lens formation layer 21, a coupling portion is formed between adjacent lens shapes. Further, heat treatment (burning) is performed at a temperature higher than a softening temperature of glass, thereby producing the microlens 202 as shown in FIG. 12E. In the microlens array of this embodiment, adjacent lenses are coupled through a glass material of the lens.

In the method of manufacturing a microlens array substrate according to this embodiment, the focusing characteristics of the lens do not change though the glass is softened and contracted due to heat treatment.

### Third Embodiment

As a third exemplary embodiment, an optical component which is manufactured by the manufacturing method of the first embodiment is described hereinafter. As an example of the optical component, a microlens array substrate in which a microlens array is formed as an optical functional part above a transparent substrate is described hereinafter.

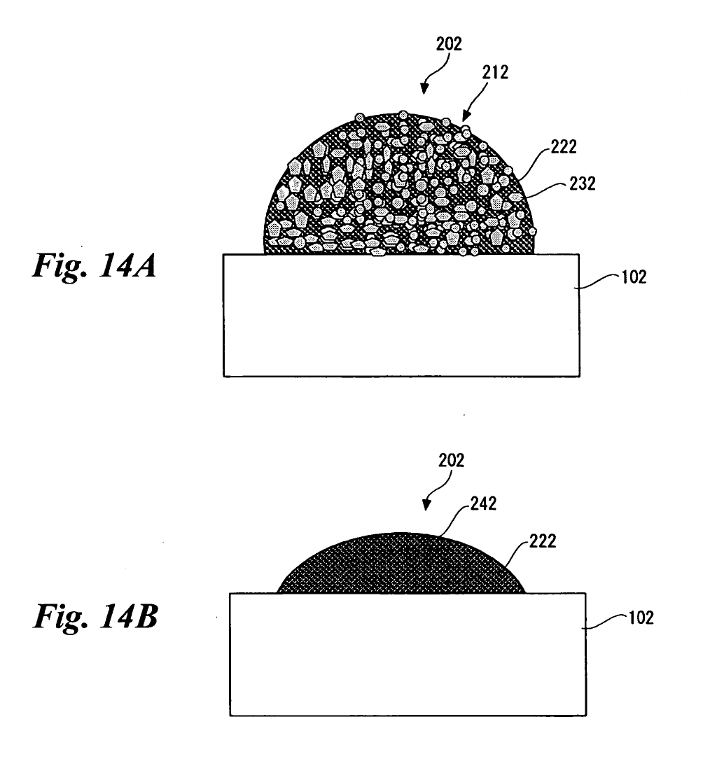

The microlens array substrate according to the third embodiment is described hereinbelow with reference to FIGS. 14A and 14B. FIGS. 14A and 14B are partial sectional views of the microlens array, and one microlens portion is illustrated therein. FIG. 14A shows the state before burning, and FIG. 14B shows the state after burning. In the microlens array substrate, the number of microlenses which corresponds to the number of pixels of a liquid crystal display are formed as detailed later.

The microlens array 2 is formed on the transparent substrate 102. The microlens array 2 includes a plurality of microlenses. In the microlens array 2 of this example, adjacent microlenses 202 are coupled, and the microlenses are integrally formed entirely on the microlens array substrate.

The transparent substrate 102 according to the third embodiment is used for a liquid crystal display. It is a glass substrate in which a switching element such as TFT and an electrode are formed on its surface. It is preferred that the glass substrate does not substantially contain alkali metal oxide because if alkali metal oxide is contained in the glass, alkali ion is dispersed in a semiconductor substance deposited during heat treatment to cause deterioration in film characteristics. It is also preferred that the glass substrate is chemical resistant so that it is not degraded by chemicals such as various acids and alkalis used during a photo etching process. It is further preferred that the glass substrate has a high distortion point, specifically 600° C. or higher, so as to prevent pattern deviation due to heat contraction of the glass substrate during a liquid crystal fabrication process such as film deposition. In addition, the glass substrate preferably has suitable melting characteristics in order to prevent melting defect which is unsuitable as a substrate from occurring in the glass. Furthermore, the glass substrate preferably has thermal expansion coefficient which is close to the thermal expansion coefficient of the microlens array 2 or materials such as a switching element or electrode which are formed on the surface. The thermal expansion coefficient αb of the transparent substrate 102 may be 30*10⁻⁷(/° C.)<αb<50*10⁻⁷(/° C.), for example, though it varies according to a glass material used.

The microlens array substrate before burning shown in FIG. 14A is produced by depositing a photosensitive glass paste film composed of two kinds of glass powder and photosensitive resin (resist) on the transparent substrate 102 and then performing exposure and development in the manufacturing process detailed earlier. The microlens 202 of this embodiment is mainly composed of photosensitive resin 212, high-melting glass powder 222, and low-melting glass powder 232. The volume percent of the glass contained in the photosensitive glass paste is preferably 30% to 50%. The refractive index of the glass powder and the photosensitive resin is preferably substantially equal.

The photosensitive glass paste is the same as that described in the first embodiment and thus not described hereinafter.

As the photosensitive resin, negative photoresist is used in the first embodiment and positive photoresist is used in the second embodiment. The photosensitive resin used herein may be either negative photoresist or positive photoresist. Compared with positive photoresist, negative photoresist is preferred to form a polygonal lens. The use of positive photoresist causes a problem that reflowing at high temperature results in rounding of corners of a polygonal shape, thus unable to maintain the polygonal shape. However, if a lens is circular or it is polygonal which does not require high accuracy, the use of positive resist is possible.

The high-melting glass powder 222 is made of a material having lower thermal expansion coefficient than the transparent substrate 102 and the low-melting glass powder 232. It is preferred to use the material having thermal expansion coefficient α1 of 5*10⁻⁷(/° C.)<α1<30*10⁻⁷(/° C.). If the softening point of the high-melting glass powder 222 is T1, ceramics glass or quartz glass of T1>700° C. is preferably used for the high-melting glass powder 222. For example, the high-melting glass powder 222 may be made of quartz glass with thermal expansion coefficient of 6*10⁻⁷(/° C.) and refractive index of 1.46.

The low-melting glass powder 232 is made of a material having higher thermal expansion coefficient than the transparent substrate 102 and the high-melting glass powder 222. It is preferred to use the material having thermal expansion coefficient α2 of 50*10⁻⁷(/° C.)<α2<150*10⁻⁷(/° C.). If the softening point of the low-melting glass powder 232 is T2, a material of 400° C.<T2<675° C. is preferably used for the low-melting glass powder 232.

The refractive index of the high-melting glass powder 222 and the low-melting glass powder 232 is preferably substantially equal in order to prevent reduction in light use efficiency due to scattering and refraction by a difference in refractive index at their interface. If the softening point of the high-melting glass powder 222 is T1 and the softening point of the low-melting glass powder 232 is T2, it is preferred that T1−T2>25° C. The weight percentage of the high-melting glass powder 222 with respect to the low-melting glass powder 232 is preferably between 5% and 30%.

FIG. 14B shows a partial cross-section of the microlens array substrate after burning. As a result of the burning, the photosensitive resin 212 (synthetic resin) which is contained in the microlens 202 is destructed, and the low-melting glass powder 232 is melted to become a low-melting glass matrix 242. The high-melting glass powder 222 remains in granular form without being melted. After the burning process, the microlens 202 contracts as a whole, and the height of the microlens 202 may be about 40% of that before the burning, for example. After the burning process, b-hydrofluoric acid treatment is performed to smooth the lens surface. If the high-melting glass powder 222 is a quartz glass which is not resistant to hydrofluoric acid, it is possible to melt the high-melting glass powder 222 which causes unevenness on the lens surface as a result of the b-hydrofluoric acid treatment, thus enabling smoothing.

In the microlens array 2 of this embodiment, adjacent lenses 202 are coupled through a glass material which forms the lens. The thickness δ (thickness after burning) of the transparent substrate 102 from the top surface at the boundary between the lenses coupled by the glass material is preferably 0.1 μm≦δ≦200 μm, more preferably 0.5 μm≦δ≦50 μm and further preferably 1 μm≦δ≦10 μm.

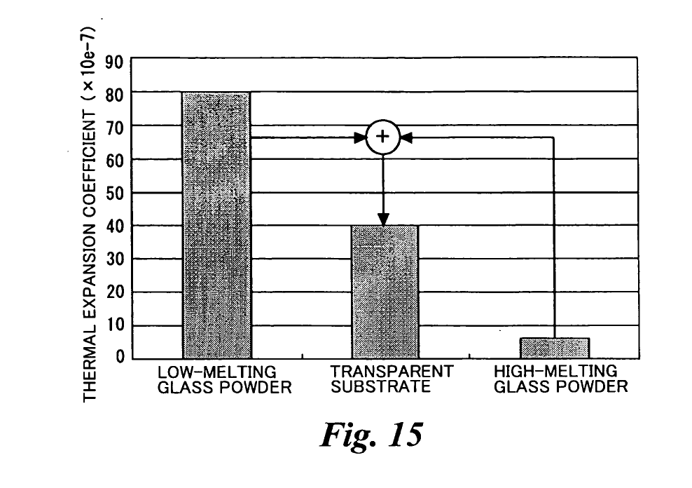

As described earlier, the thermal expansion coefficient α1 of the high-melting glass powder 222, the thermal expansion coefficient α2 of the low-melting glass powder 232, and the thermal expansion coefficient αb of the transparent substrate 102 are: α1<αb<α2. FIG. 15 shows relationship of the thermal expansion coefficient α1 of the high-melting glass powder 222, the thermal expansion coefficient α2 of the low-melting glass powder 232, and the thermal expansion coefficient αb of the transparent substrate 102. According to this embodiment which forms the microlens 202 by the high-melting glass powder 222 having lower thermal expansion coefficient and the low-melting glass powder 232 having higher thermal expansion coefficient than the thermal expansion coefficient of the transparent substrate 102, the thermal expansion coefficient of the microlens 202 can be adjusted close to that of the transparent substrate 102. Specifically, if the expansion coefficient of the transparent substrate 102 is αb and the expansion coefficient of the microlens array 2 is αm, an absolute value of (αb−αm)/αb is preferably 0.5 or less. Thus, the ratio of a difference between αb and αm with respect to αb is preferably 50% or less. Because the adjusted microlens 202 and the transparent substrate 102 have substantially the same thermal expansion coefficient, the stress which occurs due to a difference in thermal expansion coefficient can be reduced, and the occurrence of birefringence or crack can be suppressed. The ratio of a difference between αb and am with respect to αb is more preferably 30% or less, which further improves polarization characteristics.

### Fourth Embodiment

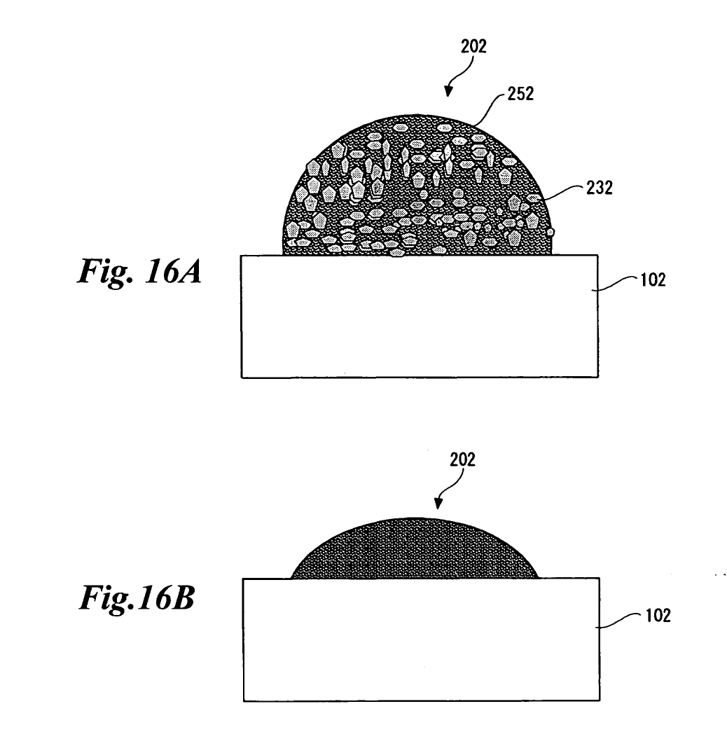

A microlens array substrate according to a fourth exemplary embodiment of the present invention is described hereinafter with reference to FIGS. 16A and 16B. FIGS. 16A and 16B are partial sectional views of the microlens array substrate, and one microlens portion is illustrated therein. FIG. 16A shows the state before burning, and FIG. 16B shows the state after burning.

The transparent substrate 102 of the forth embodiment is the same as the transparent substrate of the first embodiment and thus not described hereinafter.

The microlens array substrate before burning shown in FIG. 16A is produced by depositing a photosensitive glass paste film composed of two kinds of glass powder and photosensitive resin on the transparent substrate 102 and then performing exposure and development. The microlens 202 of this example is mainly composed of photosensitive resin 252 in which high-melting glass powder, which is so-called nanoparticles, is dispersed and the low-melting glass powder 232. The volume percent of the glass contained in the photosensitive glass paste is preferably 30% to 50%. The refractive index of the glass powder and the photosensitive resin is preferably substantially equal.

The photosensitive resin is the same as that described in the first embodiment and thus not described hereinafter.

The high-melting glass powder which is dispersed in the photosensitive resin 252 is made of a material having lower thermal expansion coefficient than the transparent substrate 102 and the low-melting glass powder 232. It is preferred to use the material having thermal expansion coefficient α1 of 5*10⁻⁷(/° C.)<α1<30*10⁻⁷(/° C.). The high-melting glass powder may be Ta₂O₅ having high refractive index, for example. The thermal expansion coefficient of Ta₂O₅ is 8*10⁻⁷(/° C.), and a refractive index is 2.20. The high-melting glass powder in the fourth embodiment is so-called nanoparticles, whose average particulate diameter is preferably 50 nm or smaller and more preferably 30 nm or smaller. In the third embodiment described above, the high-melting glass powder and the low-melting glass powder having similar refractive index are used in order to prevent reduction in light use efficiency due to scattering and refraction by a difference in refractive index at their interface. On the other hand, the fourth embodiment uses the high-melting glass powder whose particulate size is so small that is not recognized by light, and therefore it is possible to use a material whose refractive index is largely different from that of the low-melting glass powder. Therefore, it is possible to use a material with high refractive index such as Ta₂O₅ as the high-melting glass powder, enabling the manufacturing of a microlens with high refractive index. If the microlens has high refractive index, the lens height can be reduced, thus suitable for use in equipments with space limitations. Particularly, a high refractive index microlens has a high numerical aperture and enables reduction in focal length, thus enabling efficient focusing of light on an aperture in TFT or reflective electrode even if the thickness of the transparent substrate 102 is small, thereby increasing high use efficiency.

The low-melting glass powder 232 is made of a material having higher thermal expansion coefficient than the transparent substrate 102 and the high-melting glass powder 222. It is preferred to use the material having thermal expansion coefficient α2 of 50*10⁻⁷(/° C.)<α2<150*10⁷(/° C.). If the softening point of the low-melting glass powder 232 is T2, a material of 400° C.<T2<675° C. (eg. about 600° C.) is preferably used for the low-melting glass powder 232.

It the softening point of the high-melting glass powder is T1 and the softening point of the low-melting glass powder 232 is T2, it is preferred that T1−T2>25° C. The weight percentage of the high-melting glass powder with respect to the low-melting glass powder 232 is preferably between 5% and 30%.

FIG. 16B shows a partial cross-section of the microlens array substrate after burning. As a result of the burning, the photosensitive resin 212 (synthetic resin) which is contained in the microlens 202 is destructed, and the low-melting glass powder 232 is melted. The high-melting glass powder remains in granular form without being melted, but because the particular size is very small as described above, the lens surface is substantially smooth. Therefore, there is no need to smoothing process such as b-hydrofluoric acid treatment, which simplifies the manufacturing process. After the burning process, the microlens 202 contracts as a whole, and the height of the microlens 202 may be about 40% of that before the burning, for example. In the microlens array 2 of the fourth embodiment, the adjacent microlenses 202 are coupled through a glass material of the lens.

According to the fourth embodiment which forms the microlens 202 by the high-melting glass powder having lower thermal expansion coefficient and the low-melting glass powder 232 having higher thermal expansion coefficient than the thermal expansion coefficient of the transparent substrate 102, the thermal expansion coefficient of the microlens 202 can be adjusted close to that of the transparent substrate 102. Because the microlens 202 and the transparent substrate 102 have substantially the same thermal expansion coefficient, the stress which occurs due to a difference in thermal expansion coefficient can be reduced, and the occurrence of birefringence or crack can be suppressed.

Further, the fourth embodiment uses nanoparticulates having average particulate diameter of 50 nm as the high-melting glass powder, which allows the microlens 202 to have higher refractive index.

The microlenses as described in the third and fourth embodiments are composed of two kinds of glass powders, high-melting glass powder and low-melting glass powder, it is not limited thereto, and the microlens may be composed of three of more kinds of glass powders.

### Fifth Embodiment

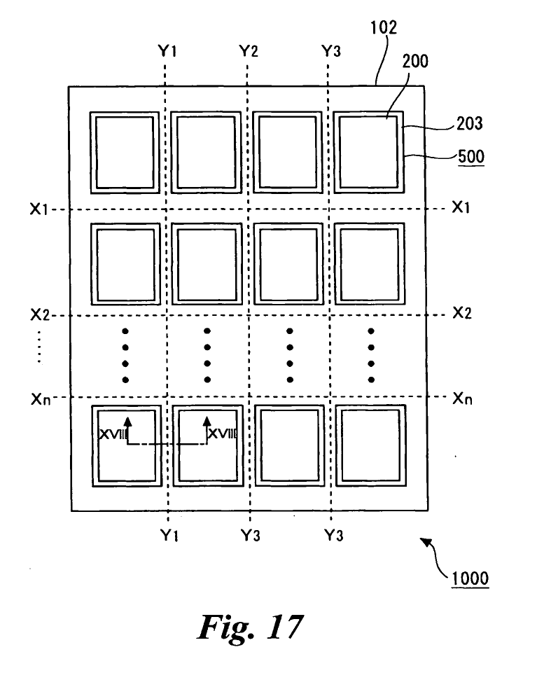

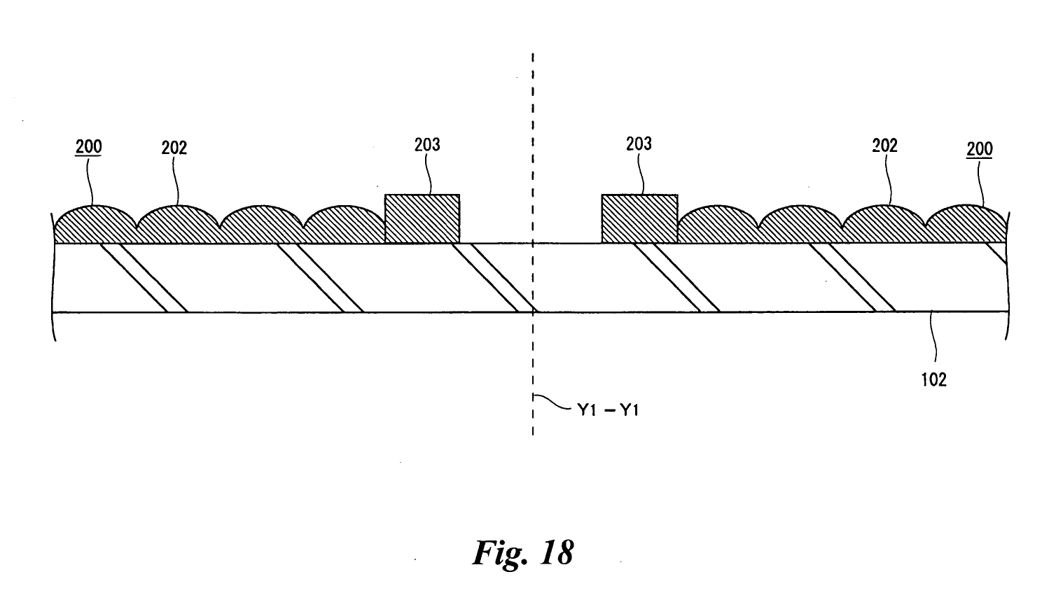

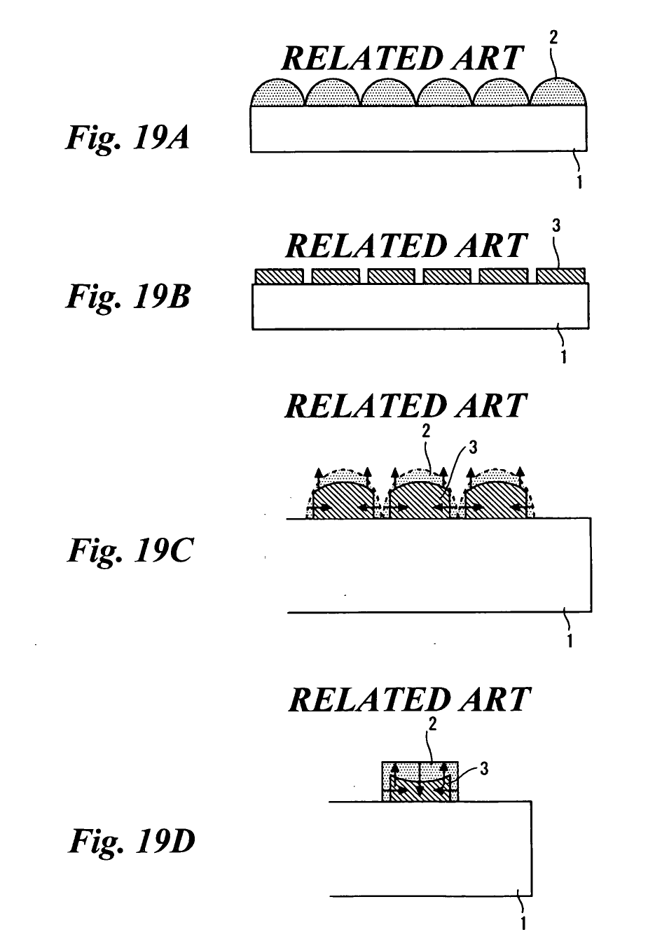

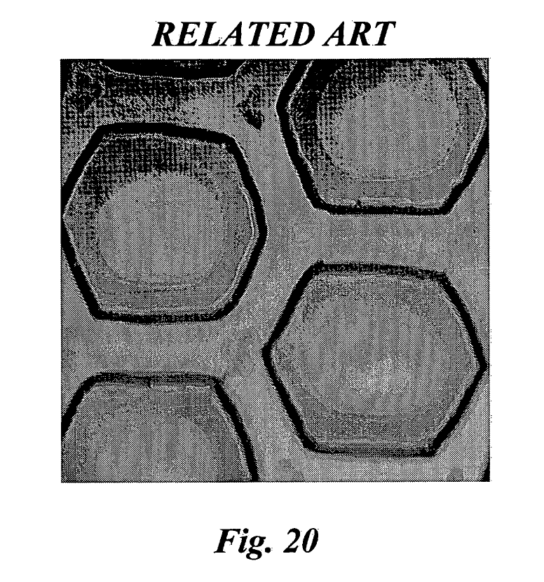

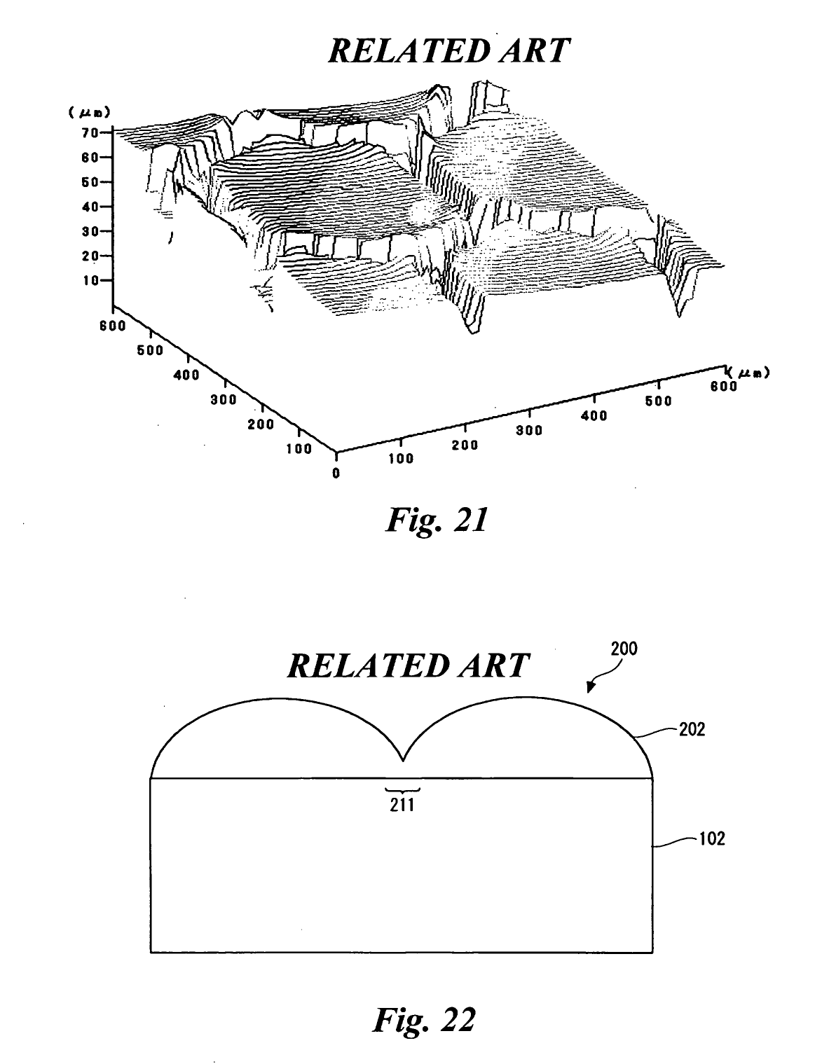

In a fifth exemplary embodiment of the present invention, a mother substrate used for producing a plurality of microlens array substrates is described hereinafter with reference to the drawings. The fifth embodiment describes the case of using the manufacturing method of the first embodiment by referring to FIGS. 1A to 1E as needed, by way of illustration. FIG. 17 is a plan view of a mother substrate when viewed from the plane on which microlens arrays are formed. FIG. 18 is a cross-sectional view along line XVIII-XVIII in FIG. 17.

As shown in FIGS. 17 and 18, on a mother substrate 1000, a plurality of microlens arrays 200 and rims 203 surrounding each array are arranged in matrix with a certain space therebetween. Specifically, the adjacent microlens arrays 200 are separated from each other, and the adjacent rims 203 are also separated from each other as illustrated in FIGS. 17 and 18.

Referring to FIG. 17, cutting lines X1-X1, X2-X2, . . . , Xn-Xn, Y1-Y1, Y2-Y2, Y3-Y3 are set within a space between the adjacent microlens arrays 200. By cutting the mother substrate 1000 along the cutting lines X1-X1 and so on, a plurality of microlens substrates 500 can be obtained at a time from the mother substrate 1000. Referring then to FIG. 18, each cutting line X1-X1 or the like is set within a space between the adjacent rims 203. The space between the outer walls of the adjacent rims 203 is set so as to prevent chip-off of the rim 203 when polishing the outer edges or corners of the microlens array substrate 50 after cutting to avoid cullet, for example.

A method of manufacturing a mother substrate and a microlens array substrate according to the first embodiment of the present invention is described hereinafter. FIGS. 1A to 1E are views showing a method of manufacturing a microlens array substrate according to the first embodiment. FIGS. 1A to 1E schematically illustrate a cross-section of a formation area of the microlens array 200 of the mother substrate 1000 shown in FIG. 17.

In the fifth embodiment, the transparent substrate 102 may be a glass substrate having a thickness of 400 μm to 500 μm, for example, referring to FIG. 1A. Referring next to FIG. 1B, photosensitive glass paste is coated and deposited all over one surface of the transparent substrate 102, thereby forming a lens formation layer 21.

Referring then to FIG. 1C, a grayscale mask 30 is placed on the opposite side of the surface where the lens formation layer 21 is formed and light is exposed to the formation area of the microlens array 200 as shown in FIG. 17. The adjacent formation areas of the microlens arrays 200 are separated from each other as shown in FIG. 17. In each formation area of the microlens array 200, the intensity of the exposure light applied through the grayscale mask 30 is modified by the lens formation area of the grayscale mask 30.

Specifically, the light intensity is modified so that the exposure intensity decreases concentrically from the center of the lens formation area at highest. By the exposure light whose intensity is modified by the lens formation area of the grayscale mask 30, the lens formation layer 21 is cured into a lens shape. The grayscale mask 30 is patterned to enable simultaneous formation of the microlens 202 and the rim 203 shown in FIG. 17. By exposing the formation area of the rim 203 to light using the grayscale mask 30, it is cured into a rim shape. The simultaneous formation of a plurality of microlenses 202 and rims 203 using the same grayscale mask 30 enables the efficient production of the microlens arrays 200 and the rims 203 on the transparent substrate 102.

Referring then to FIG. 1D, exposure and development are performed on the lens formation layer 21. Because the exposure and development are not performed in the area other than the formation areas of the microlens arrays 200 and the rims 203, the lens formation layer 21 is removed completely in this area.

Referring further to FIG. 1E, heat treatment (burning) is performed at a temperature higher than a glass softening temperature and then slow-cooling is performed, thereby forming a plurality of microlenses 202 in the formation area of the microlens arrays 200 and also forming the rims 203 in the formation area of the rims 203 at the same time as shown in FIG. 17. The height of the microlens 202 may be about 15 μm, and the height of the rim 203 may be about 20 μm. Because the photosensitive resin is destructed by the burning process, the microlens array 200 and the rim 203 are composed only of glass. The adjacent microlens arrays 200 are separated from each other, and the adjacent rims 203 are also separated from each other.

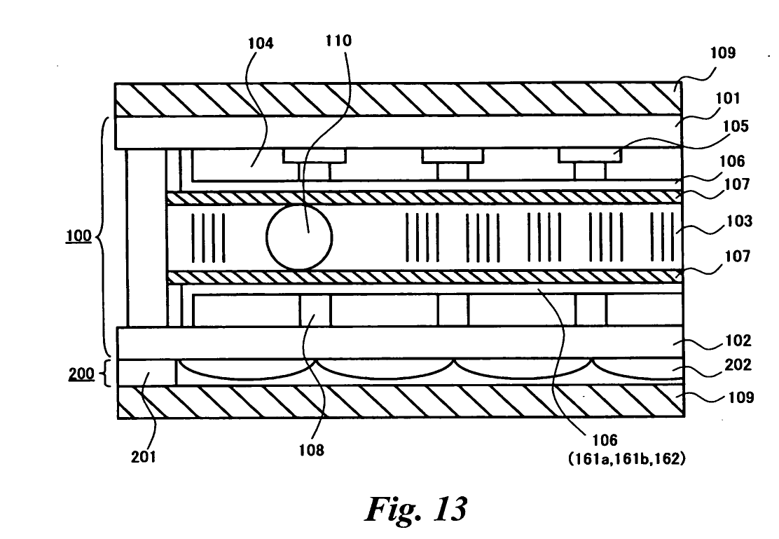

Consequently, the mother substrate 1000 in which the microlens arrays 200 and the rims 203 are formed on the transparent substrate 102 can be obtained as shown in FIG. 17. On the other side of the mother substrate 1000 opposite from the formation surface of the microlens 202, a transparent substrate 106, a TFT 108 and an aligning film 107 are formed as shown in FIG. 13.

The adjacent microlenses 202 are coupled by the glass material of the microlens 202, which serves as the coupling portion 211. The height of the coupling portion 211 may be about 10 μm or smaller, for example. Comparison between FIGS. 1D and 1E shows that the lens formation layer 21 contracts in the lens height direction (optical axis direction) due to burning. Though a contract force in plane direction (lens array direction) of the microlens array 200 is acting, the adjacent lenses are coupled through the coupling portion 211 and thus not separated form each other, and the contract force is relaxed by a reactive force which occurs in the transparent substrate 102 along the direction parallel to the lens array direction. Accordingly, the outer edge of the lens does not rise upward (in the direction away from the transparent substrate 102) and the lens contracts substantially uniformly in the height direction, thereby preventing deterioration of the focusing characteristics of the lens.

Because the adjacent microlens arrays 200 and the adjacent rims 203 are separated from each other after burning, even if a difference exists in thermal expansion coefficient between the microlens arrays 200 or the rims 203 and the glass transparent substrate 102, the occurrence of residual stress or residual strain between the microlens array 200 and the transparent substrate 102 during slow-cooling after burning can be reduced. As a result, the warpage of the glass transparent substrate 102 or the crack in the microlens array 200 which occur due to a difference in thermal expansion coefficient between the glass transparent substrate 102 and the microlens array 200 can be suppressed.

Further, by cutting the mother substrate 1000 along the cutting lines X1-X1, . . . , Y1-Y1, . . . and so on, a plurality of microlens substrates 500 are produced from the mother substrate 1000. The cutting of the mother substrate may employ a scriber-breaker method, for example. The scriber-breaker method forms a scribe line by a scriber and then applies pressure to the scribe line to thereby cut the mother substrate 1000.

After that, the outer edges or the corners of each microlens array substrate 500 are polished. The polishing process prevents the occurrence of cullet. Because the adjacent rims 203 are separated from each other, a polishing area can be secured at the outer edge of the microlens array substrate 500. This prevents chip-off of the rim 203 when polishing the outer edges or corners of the microlens array substrate 500.

The mother substrate 1000 may be cut alone. Alternatively, it is possible to adhere another mother substrate (not shown) for producing a plurality of first transparent substrates 101 as shown in FIG. 13 to the mother substrate 1000 by a sealing material 111 and cut the both mother substrates at the same time. It is also possible to adhere the substrate 1000 and another mother substrate by the sealing material 111, inject liquid crystals in the space surrounded by the both mother substrates and the sealing material 111 and seal it, and cut the both mother substrates at the same time. The formation area of the transparent substrate 106 on another mother substrate corresponds to the formation area of the transparent substrate 106 on the mother substrate 1000.

### Sixth Embodiment

In a sixth exemplary embodiment of the preset invention, a mother substrate for producing a plurality of microlens array substrates is described hereinafter with reference to the drawings. The sixth embodiment describes the case of using the manufacturing method of the second embodiment by referring to FIGS. 12A to 12E as needed, by way of illustration.

A method of manufacturing a mother substrate and a microlens array substrate according to the second embodiment of the present invention is described hereinafter. FIGS. 12A to 12E schematically illustrate a cross-section of a formation area of the microlens array 200 of the mother substrate 1000 shown in FIG. 17.

Referring first to FIGS. 12A and 12B, a lens formation layer 21 is formed all over one surface of the transparent substrate 102 made of glass.

Referring then to FIG. 1C, light is exposed to the formation areas of the microlens arrays 200 and the area other than the formation area of the microlens array 200 and the rim 203. The formation areas of the microlens arrays 200 are separated from each other as shown in FIG. 17. In each formation area of the microlens array 200, the intensity of the exposure light applied through the grayscale mask 30 is modified by the lens formation area of the grayscale mask 30.

Specifically, the light intensity is modified so that the exposure intensity increases concentrically from the center of the lens formation area at lowest. As a result of applying the exposure light whose intensity is modified by the lens formation area of the grayscale mask 30, the part of the lens formation layer 21 except for the lens shape area is decomposed by a developer. Further, as a result of exposing the areas other than the formation areas of the microlens array 200 and the rim 203, the lens formation layer 21 is decomposed in those areas.

The grayscale mask 30 is patterned to enable simultaneous formation of the microlens 202 and the rim 203 as shown in FIG. 17. By exposing the formation area of the rim 203 to light using the grayscale mask 30, it is cured into a rim shape.

Referring then to FIG. 12D, exposure and development are performed. Then, heat treatment (burning) is performed at a temperature higher than a glass softening temperature and then slow-cooling is performed, thereby forming a plurality of microlenses 202 in the formation area of the microlens arrays 200 and also forming the rims 203 in the formation area of the rims 203 at the same time as shown in FIG. 17. Because the photosensitive resin is destructed, The height of the microlens 202 may be about 15 μm, and the height of the rim 203 may be about 20 μm. Because the photosensitive resin is destructed by the burning process, the microlens array 200 and the rim 203 are composed only of glass. The adjacent microlens arrays 200 are separated from each other, and the adjacent rims 203 are also separated from each other.

Consequently, the mother substrate 1000 in which the microlens arrays 200 and the rims 203 are formed on the transparent substrate 102 can be obtained as shown in FIG. 17. The adjacent microlenses 202 are coupled by a glass material to form the microlens 202, which serves as the coupling portion 211.

Because the adjacent microlens arrays 200 and the adjacent rims 203 are separated from each other after burning, even if a difference exists in thermal expansion coefficient between the microlens arrays 200 or the rims 203 and the glass transparent substrate 102, the occurrence of residual stress or residual strain between the microlens array 200 and the transparent substrate 102 during slow-cooling after burning can be reduced. As a result, the warpage of the glass transparent substrate 102 or the crack in the microlens array 200 which occur due to a difference in thermal expansion coefficient between the glass transparent substrate 102 and the microlens array 200 can be suppressed.

Applications of a Microlens Array Substrate

The microlens array substrate of this embodiment can be used for a liquid crystal display. FIG. 13 is a view showing a cross-section of a liquid crystal display having the microlens array substrate. The liquid crystal display is a semi-transmissive liquid crystal display. The liquid crystal display of FIG. 13 includes a liquid crystal panel 100 and a microlens array 200. The liquid crystal panel 100 is composed of two transparent substrates 101 and 102 with a liquid crystal layer 103 interposed therebetween.

A transparent electrode 106 and an aligning film 107 are sequentially laminated between a color filter layer 104 and a liquid crystal layer 103. In the transparent substrate 102 on the backside of the liquid crystal panel 100, a TFT 108 is formed and further the transparent electrode 106 and the aligning film 107 are laminated. A pixel electrode 161 and a line 162 are formed on the transparent electrode 106 on the TFT 108 side. The pixel electrode 161 includes an aperture 161a and a reflective portion 161b. The light incident on the liquid crystal panel 100 through the transparent substrate 102 passes through the aperture 161a. The reflective portion 161b serves as a light reflector for reflecting the light incident through the transparent substrate 101.

The microlens array 200 is placed on the backside of the transparent substrate 102. The microlens array 200 includes the rims 203 and the microlenses 202. The microlens array 200 focuses the light from a backlight on the aperture 161a to thereby increase light use efficiency and enhance luminance. For example, the light use efficiency increased about three times in a semi-transmissive liquid crystal display, and increased about two times in a transmissive liquid crystal display. A polarizing plate 109 is an optical component having a function to transmit specific polarized light of incident light, which are adhered to both surfaces of the transparent substrates 101 and 102. A spacer 110 is a resin particle for adjusting the height of the liquid crystal layer 103 between the transparent substrates 101 and 102. A plurality of spacers 110 are scattered entirely on the transparent substrates 101 and 102.

The microlens array substrate of this embodiment is not restricted to a liquid crystal display and may be used for other applications.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. An optical component comprising:
a transparent substrate; and
a plurality of lenses formed on the transparent substrate and made mainly of glass,
wherein adjacent lenses are coupled by the same glass material as the lenses, and
an expansion coefficient of the lenses is substantially equal to an expansion coefficient of the transparent substrate.

2. The optical component according to claim 1, wherein a thickness δ of a coupling portion between the adjacent lenses is 0.1 μm≦δ≦200 μm.

3. The optical component according to claim 1, wherein when a curve of a cross-section of a given line connecting between both foot ends of each lens through a center top of the lens is g(x), and a curve of an ideal sphere fitted to g(x) by least squares method is f(x), a spherical deviation indicated by a root mean square value (RMS value) of a difference in height between f(x) and g(x) is 0.05 μm or smaller if the lens is a spherical lens.

4. The optical component according to claim 1, wherein a surface roughness Ra of the lenses is 0.05 μm or smaller.

5. The optical component according to claim 1, wherein the transparent substrate is a transparent substrate where an electrode is formed, which a liquid crystal display consists of.

6. The optical component according to claim 1, wherein the lenses contain a first glass material and a second glass material, and
if an expansion coefficient of the first glass material is α1, an expansion coefficient of the second glass material is α2, and an expansion coefficient of the transparent substrate is αb, α1<αb<α2 is satisfied.

7. The optical component according to claim 6, wherein a refractive index of the first glass material and a refractive index of the second glass material are substantially equal.

8. The optical component according to claim 6, wherein an average particulate diameter of the first glass material is 50 nm or smaller.

9. A microlens array substrate comprising:
a glass substrate; and
a plurality of microlenses formed on the glass substrate and made mainly of glass,
wherein adjacent microlenses are coupled by the same glass material as the lenses, and
an expansion coefficient of the microlenses is substantially equal to an expansion coefficient of the glass substrate.

10. The microlens array substrate according to claim 9, wherein a thickness δ of a coupling portion between the adjacent microlenses is 0.1 μm≦δ≦200 μm.

11. The microlens array substrate according to claim 9, wherein
when a curve of a cross-section of a given line connecting between both foot ends of each microlens through a center top of the microlens is g(x), and a curve of an ideal sphere fitted to g(x) by least squares method is f(x), a spherical deviation indicated by a root mean square value (RMS value) of a difference in height between f(x) and g(x) is 0.05 μm or smaller if the microlens is a spherical lens.

12. The microlens array substrate according to claim 9, wherein a surface roughness Ra of the microlenses is 0.05 μm or smaller.

13. The microlens array substrate according to claim 9, wherein the glass substrate is a transparent substrate where an electrode is formed, which a liquid crystal display consists of.

14. The microlens array substrate according to claim 9, wherein
the microlenses contain a first glass material and a second glass material, and
if an expansion coefficient of the first glass material is α1, an expansion coefficient of the second glass material is α2, and an expansion coefficient of the glass substrate is αb, α1<αb<α2 is satisfied.

15. The microlens array substrate according to claim 14, wherein a refractive index of the first glass material and a refractive index of the second glass material are substantially equal.

16. The microlens array substrate according to claim 14, wherein adjacent microlenses are coupled by a glass material.

17. The microlens array substrate according to claim 14, wherein the glass substrate is a glass substrate where an electrode is formed, which a liquid crystal display consists of.

18. The microlens array substrate according to claim 17, wherein
30*10⁻⁷(/° C.)<αb<50*10⁻⁷(/° C.), 5*10⁻⁷(/° C.)<α1<30*10⁻⁷(/° C.) and 50*10⁻⁷(/° C.)<α2<150*10⁻⁷(/° C.) are satisfied.

19. The microlens array substrate according to claim 17, wherein if a softening point of the first glass material is T1 and a softening point of the second glass material is T2, T1−T2>25° C. is satisfied.

20. The microlens array substrate according to claim 17, wherein if a softening point of the first glass material is T1, the first glass material is ceramic glass or quartz glass of T1>700° C.

21. The microlens array substrate according to claim 17, wherein if a softening point of the second glass material is T2, 400° C.<T2<675° C. is satisfied.

22. The microlens array substrate according to claim 20, wherein if a softening point of the second glass material is T2, 400° C.<T2<675° C. is satisfied.

23. The microlens array substrate according to claim 17, wherein a weight percentage of the first glass material is between 5% and 30% with respect to the second glass material.

24. The microlens array substrate according to claim 17, wherein an average particle diameter of the first glass material is 50 nm or smaller.

25. A liquid crystal display comprising:
a transparent substrate where an electrode is formed; and
a plurality of lenses formed on the transparent substrate and made mainly of glass,
wherein adjacent lenses are coupled by the same glass material as the lenses, and
an expansion coefficient of the lenses is substantially equal to an expansion coefficient of the transparent substrate.

26. A liquid crystal display comprising:
a glass substrate where an electrode is formed; and
a plurality of microlenses formed on the glass substrate and made mainly of glass,
wherein adjacent microlenses are coupled by the same glass material as the lenses, and
an expansion coefficient of the microlenses is substantially equal to an expansion coefficient of the glass substrate.

27. A method of manufacturing an optical component including a transparent substrate and a plurality of lenses formed on the transparent substrate and made mainly of glass, comprising:
depositing on the transparent substrate a lens formation layer where a plurality of lenses are formed; and
burning the lens formation layer to form the lenses in which adjacent lenses are coupled to each other.

28. The method of manufacturing an optical component according to claim 27, wherein
the deposition of the lens formation layer comprises:
coating photosensitive glass paste composed of glass powder and photosensitive resin on the transparent substrate; and
exposing the coated photosensitive glass paste to light through a grayscale mask and developing the photosensitive glass paste to form the lenses having a coupling portion.

29. The method of manufacturing an optical component according to claim 27, wherein
a thickness δ of a coupling portion between the adjacent lenses is 0.1 μm≦δ≦200 μm.

30. The method of manufacturing an optical component according to claim 27, wherein
the deposition of the lens formation layer comprises:
depositing on the transparent substrate a lens formation layer containing first glass powder having a lower thermal expansion coefficient than the transparent substrate, and second glass powder having a higher thermal expansion coefficient than the transparent substrate.

31. The method of manufacturing an optical component according to claim 30, wherein
the deposition of the lens formation layer comprises:
coating photosensitive glass paste composed of the first glass powder, the second glass powder and photosensitive resin on the transparent substrate; and
exposing the coated photosensitive glass paste to light through a grayscale mask and developing the photosensitive glass paste to form a plurality of lenses.

32. A method of manufacturing a microlens array substrate including a glass substrate, and a plurality of microlenses formed on the glass substrate and made mainly of glass, comprising:
depositing on the glass substrate a lens formation layer where a plurality of microlenses are formed; and
burning the lens formation layer to form the microlenses in which adjacent lenses are coupled to each other.

33. The method of manufacturing a microlens array substrate according to claim 32, wherein
the deposition of the lens formation layer comprises:
coating photosensitive glass paste composed of glass powder and photosensitive resin on the glass substrate; and
exposing the coated photosensitive glass paste to light through a grayscale mask and developing the photosensitive glass paste to form the microlenses having a coupling portion.

34. The method of manufacturing a microlens array substrate according to claim 32, wherein
a thickness δ of a coupling portion between the adjacent microlenses is 0.1 μm≦δ≦200 μm.

35. The method of manufacturing a microlens array substrate according to claim 32, comprising:
depositing on the glass substrate a lens formation layer containing first glass powder having a lower thermal expansion coefficient than the glass substrate, and second glass powder having a higher thermal expansion coefficient than the glass substrate, on which a plurality of microlenses are formed; and
burning the lens formation layer to form the microlenses.

36. The method of manufacturing a microlens array substrate according to claim 32, wherein:
the deposition of the lens formation layer comprises:
coating photosensitive glass paste composed of first glass powder, second glass powder, and photosensitive resin on the glass substrate; and
exposing the coated photosensitive glass paste to light through a grayscale mask and developing the photosensitive glass paste to form the microlenses.
